(19) United States
(12) Patent Application Publication
(10) Pub. No.: US 2004/0101664 A1
(43) Pub. Date: May 27, 2004

(54) Security features

(76) Inventor: Frank Puttkammer, Coswig (DE)

Correspondence Address: Law Offices of Karl Hormann, PO Box 381516, Cambridge, MA, 02238, US

(21) Appl. No.: 10/469,795

(22) PCT Filed: Feb. 28, 2002
(86) PCT No.: PCT/DE02/00750

(30) Foreign Application Priority Data
Mar. 1, 2001 (DE) 101 11 850.3

(51) Int. Cl. B32B 3/00

(52) U.S. Cl. 428/209

(57) ABSTRACT

The invention relates to security features, preferably tear strips or threads for the identification by the manufacturer or authorized control agents of products.

The security features in accordance with the invention are made up of different components, encoding means and electrically conductive layers, whereby they are connected in different arrangements to a support substrate. Layers of known perse electrically conductive polymers are utilized. In accordance with the invention, the security features are tear strips which are connected to a package, for instance by pressing, glueing or sealing. The security features constitute insurmountable technological obstacles for a forger.

The invention relates to security features, preferably tear strips or threads for identifying the genuineness of products by their manufacturer or authorized control agents.

Original manufacturer are subject to enormous material damage and image losses as a result of product piracy and unauthorized products of various branded products, for instance, in the pharmaceutical, textile and cosmetics industry as well as in the field of spare parts. Faced with product piracy and unauthorized production of high priced consumer goods which do not correspond to the quality of heir originals, the manufacturer as well as a large section of consumers are keen on the ability of testing goods for genuineness. For this purpose, they are usually provided with visible security elements. Security elements applied to the products may be holograms, for instance. A further possibility consists of providing packages with security elements. For instance, for opening the packages, threads, ribbons or twine are placed around the packaging materials. As security elements these so-called tearing means are usually of a different color, provided by a material of perceptible strength and sometimes provided with a sharp perceptible edge. One end of these tear threads is usually formed as a freely depending tongue which may be conveniently grasped by the user. The structure of this tongue—for instance its shape length or width—is also utilized as proof of quality.

Even though these measures are not employed in connection with goods of lesser value and the tear thread often consists of the same material as the package, it can increasingly be seen that the features heretofore used for identifying the genuineness are insufficient for effectively protecting the original. Based on the progressing development of techniques also accessible to forgers genuineness and security features can be easily imitated and produced. The demand for raising the technological obstacle for forgers is steadily increasing.

In many branches of the economy manufacturers suffer significant losses because of so-called “gray goods”. The producers, however, have no particular interest in testing the “gray goods” for genuineness. The product corresponds to the original and usually is available at a substantially lower price. It is here, where the main interest of the manufacturer lies as to testing for genuineness. As a matter of preference, security elements which are hidden and invisible to humans are used in this context. The consumers will not be confused by changes in design. Not knowing the kind and position of the security element is to prevent forgers from adjusting to the testing technology and testing apparatus when producing the packages for “gray goods”, for instance. A general problem in product piracy as well as in the unauthorized production is the unauthorized production of wrappings and containers or their theft for the purpose of packaging counterfeits or gray goods and thus to pretend their genuineness.

EP 0,317,202 describes a package with a tear ribbon coated with a magnetizable material for recording magnetically encoded data.

WO99/43,556 A1 describes tear threads as security elements for packages with one of more perforations which may represent company logos, for instance. Furthermore, tear threads with individual metalized sections are used which are provided with demetalized zones representing figures or letters within the metalized sections. The metalized sections may represent holograms. The combination of the optically effective security element with an electrically effective characteristic dye for encoding data has been described as well.

DE 198 08 288 A1 proposes to metalize individual sections of the tear strip with a preferred coating thickness of from 70 nm to 200 nm and to demetalized zones representing figures and letters, for instance, within these metalized sections. There is no compatibility with currently used production methods and technological production speeds. Structuring by means of masks or other covers does not yield sufficient resolution, or their life expectancy is low.

Furthermore, metalization coatings produced by printing are known. Coatings produced by metallic printing dyes make higher resolution possible depending upon the type of printing, such as, for instance scattered printing. Sectional surface resistances may be set by the selection of binding material. The brilliancy is below that of surfaces manufactured by vacuum coating methods. Since the usual processing and manufacturing speeds of >500 m/min cannot be attained, there are no useful industrial technologies, in particular vacuum technologies, for security elements realized by metalizations with sectional surface resistance changes while at the same time providing the highest possible brilliancy of the surface.

All security elements, systems and techniques hitherto described are being mastered on a large scale by forgers and often industrially utilized, so that counterfeits and “gray goods” are increasingly offered in large quantities in all markets.

Aside from overcoming the disadvantages of the prior art, it is an object of the invention to propose tear strips or threads for identifying the genuineness of products by their manufacturer or control agents. Insurmountable technological obstacle for forgers are to be proposed on the basis of the combination of metalized surfaces, surface brilliancy, electrically conductive surfaces and changes in surface resistance which is only known to the manufacturer and authorized control agents.

Before describing the invention, terms will hereafter be defined as they are understood throughout including in the claims. Integral metalization connotes a homogeneously metalized surface of homogeneous surface brilliancy. Scattered metalization connotes a non-homogeneous metalized surface or a homogeneously metalized surface including dematalizations or a homogeneously metalized surface of non-homogeneous surface brilliancy or a homogeneously metalized surface of non-homogeneous surface brilliancy and demetalizations. Substrate or support substrate designates any material onto or into which encoding means may be applied, material being understood to be, for instance, plastic or metal foil, paper, card board and textile webs. Encoding means will hereafter in the specification and patent claims to be understood to be means for securing and encoding with electrical, optical or magnetic functionalities. The most variegated tear ribbons, strips, threads and tear foils and the like will hereafter be collectively designated as tear strips. Packages are understood to be any wrappings, partial wrappings, outer packages, cartons, foils, woven materials, paper and card boards, all suitable for wrapping products of any kind.

The security elements in accordance with the invention are constructed of several different components, encoding means and electrically conductive layers, they being connected to a substrate in differing arrangements. Layers of known per se electrically conductive polymers will be utilized. In accordance with the invention the security elements are tear strips connected to a package by pressing, glueing or sealing. Utilization of electrically conductive polymers in combination with a metalization layer is predicated on a significant difference between the surface resistances (˜100 kΩ/□), a very high electrical surface resistance of the metalization layer (=200 kΩ/□) is particularly demanded. Commercial and utilized technologies for metalizations yield low surface resistances.

The coating with an electrically conductive polymer, for instance, polyethylene dioxythiophene polystyrene sulfonate (PEDT/PSS) in combination with a metalization layer is to be used as a technological obstacle for forgers, the PEDT/PSS being characterized by a surface resistance in the range of from 15-100 kΩ/□. Utilizing a primer, a surface resistance of 50 kΩ/□ is attained on PE foils.

The polymer layer is applied integrally or sectionally, it being preferably applied in a surface-modulating manner or as a scattered print. The sectionally changing surface resistances result in a readable code. This, in turn, can be easily detected in various ways, in particular by capacitive coupling. A possible automatic physical dual test of the electrically conductive polymer PEDT/PSS is advantageous for detecting the electrical conductivity on the one hand and the optical characteristic in the IR range, for instance, on the other hand. At increasing wavelength (>900 nm) and weight of application of layer thickness the IR characteristics are effectively useable. Absorption and changes in wavelength constitute measurable parameters. The dual test reduces the possibility of identifying forgeries or of the error rate of unrecognized forgeries as well as the error rate of genuine products recognized as forgeries.

A metalized surface to be used in accordance with the invention, in particular one of high brilliancy of which it would have to be assumed that it is of good electrical conductivity and that it might contain an electrically conductive security element or that by way of encoded changes in surface resistance it itself constitutes a security feature, is a further obstacle for a forger, since task, function and functionality of the metalized surface can neither be assumed nor are they obvious.

The invention, In particular, relates to security features, preferably tear strips or threads for identifying the genuineness of products by their manufacturer of authorized agents. The tears strips consist of substrates, integral or scattered metalized applications of a defined surface resistance, electrically conductive polymers also of defined surface resistance. In accordance with the invention, the surface resistance of the integral or scattered metalized application is greater than 200 kΩ/□, and the surface resistance of electrically conductive polymers lies in the range of from 15 to 100 kΩ/□. The difference between the surface resistances of the applications and of the electrically conductive polymers is greater than 100 kΩ/□. This type of inventive tear strip is connected to packages.

The construction of the tear strips, i.e. the arrangement of substrates, electrically conductive polymers, integral or scattered metalized applications, protective layers, release agents and/or adhesive layers, is selected in accordance with their intended purpose, the individual layers being interchangeable. Siliconized layers as well as transfer ribbons or layers are preferably used release layers. Depending upon purpose and utilized manufacturing technology, primers are utilized as bonding agents and which, in accordance with the invention, are suitable for smoothing the coated substrates. The electrically conductive polymers, the integral or scattered metalized applications, the substrates, and, where required, the protective layers and primers are arranged as encoding means such that their electrical or optical or magnetic functionalities may be detected by capacitive coupling, i.e. they are utilized as encoding means.

In accordance with the invention the electrically conductive polymers may be applied in sections or in a manner in which they modulate the surface or section of the surface. In this case, too, a resultant code can be detected capacitively. Similarly, sectionally or surface-modulatingly or sectional surface-modulatingly applied integral or scattered metalized applications are detectable as codes by capacitive coupling.

In accordance with the invention, the encoding means of the security elements may be affected physically or chemically. Especially the application of energy such as visible light, UV, IR or heat radiation causes the encoding means to react in a manner discernible to a testing person, as an indication of genuineness or originality., either in the tear strips or in conjunction with the package. It is, however, also within the realm of the invention to use reaction dyes as encoding means, whereby the individual components of reactions dyes react when brought into contact with one another, and thus serve as an indication of genuineness or originality. The polymer to be used in accordance with the invention preferably is a polyethylene dioxythiophene polystyrene sulfonate (PEDT/PSS).

A special embodiment of the invention provides for the joining of partial strips to a tear strip. The individual partial strips may consist, as has already been describes, of substrates, integral or scattered metalized applications and electrically conductive polymers, whereby individual partial strips may also be provided with protective layers, layers of release agent, adhesive layers and a primer. The selection and arrangement of the individual layers depends upon the desired use and upon the processing technology. Here too, different surface resistances of individual layers in the partial strips are within the ambit of the invention. The tear strips which are made identically or with a varying structure by themselves or when joined to a tear strip result in codes. Where codes are formed only after partial strips have been joined together, their precise interfitting is an essential precondition. All encoding means on the partial trips and on the tear strip may be arranged differently on the surface to which they are applied.

The invention will hereafter be explained and described in greater detail with reference to the embodiments shown in the drawings. In the drawings:

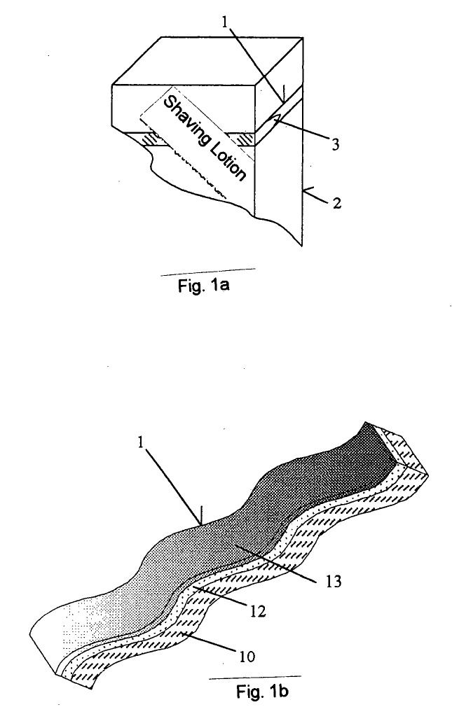

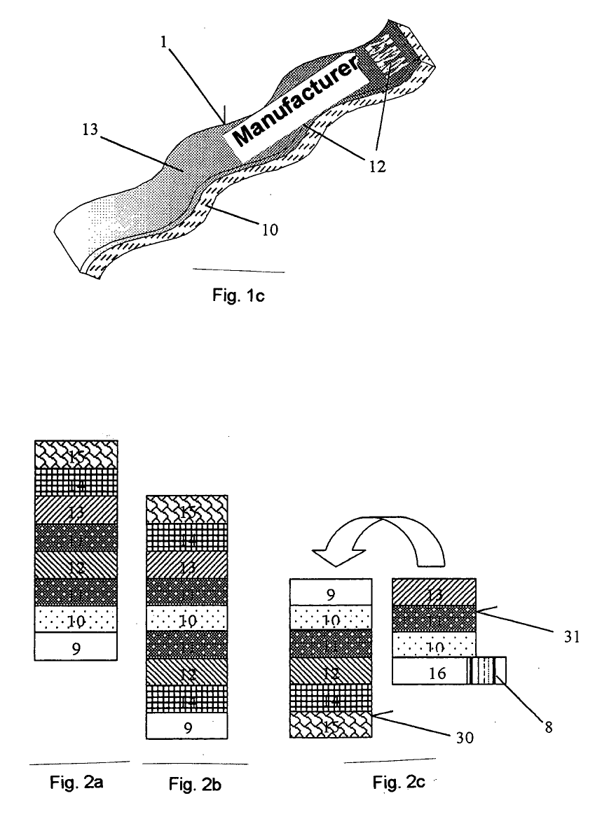

FIG. 1a is a partial view of a product in a foil wrapper with a tear strip;

FIG. 1b is a schematic partial view of a tear strip;

FIG. 1c is a schematic partial view of a tear strip with a code;

FIGS. 2a-2c are schematic views of the layer structure of different variants of tear strips;

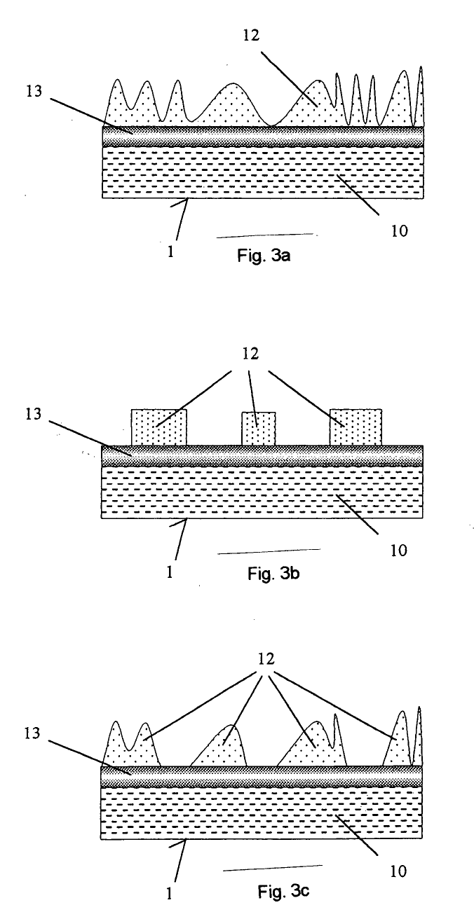

FIGS. 3a-3c schematically depict further variants of a layer structure of tear strips;

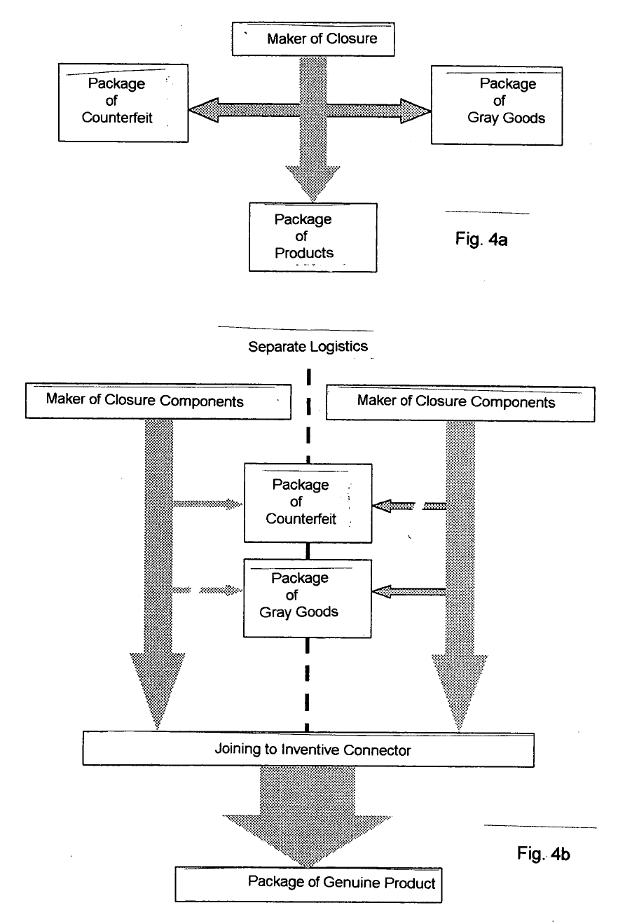

FIGS. 4a-4b depict the flow of goods in the production of tear strips and a “deviation” in the flow of goods;

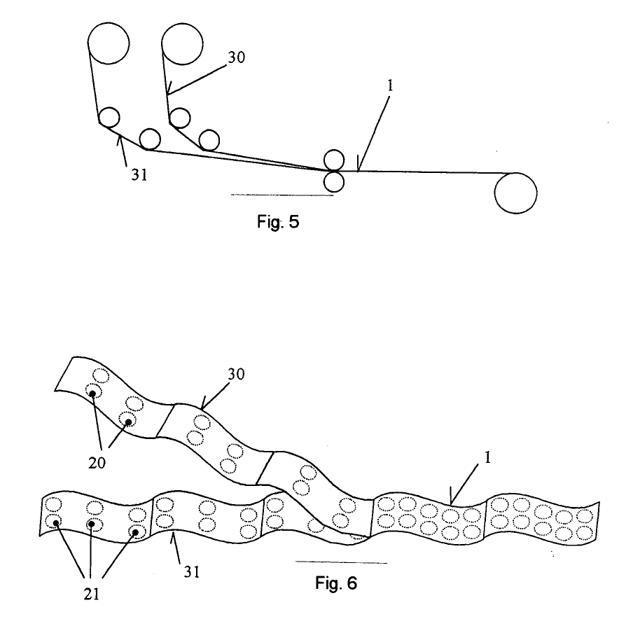

FIG. 5 schematically depicts a two-component tear strip; and

FIG. 7 schematically depicts an encoded tear strip.

### EXAMPLE 1

FIG. 1 depicts a product in a foil wrapper 2 with a tear strip 1 which, by way of example, is pressed into, glues or sealed to the foil package 2. As is usual, the tear strip 1 is structured as a flat foil which si stronger than the foil package 2. Tear strips 1 are used with a thickness of about 30-50 μm and a width of 1 mm to 2 mm. For better visibility, the tear strip 1 is often colored and that is clearly distinguished from the foil wrapper 2. For grasping the tear strip 1 its loose end is formed as a tongue 3 which extends beyond the foil wrapper 2. FIG. 1b schematically depicts a partial section of a tear strip 1 in accordance with the invention for identifying the genuineness by the manufacturer or authorized control agent. In essence, it contains a substrate 10, an integral or scattered metalized application or application layer 13 and an electrically conductive polymer 12 of a surface resistance in the order of 15-100 kΩ/□, the difference between the surface resistance of the integral or scattered metalized layer 13 and the surface resistance of the electrically conductive polymer being greater than 100 kΩ/□. The layers may be selectively interchanged.

### EXAMPLE 2

In this embodiment, a substrate 10 is provided with an integral metalized layer 13 of a surface resistance greater than 200 kΩ/□. The electrically conductive polymer 12, in this case polyethylene dioxythiophene polystyrene sulfonate, which is invisible to humans, identified the manufacturer and the date of manufacture as shown in FIG. 1c.

### EXAMPLE 3

FIG. 2a depicts a further variant of a tear strip 1. A substrate 1o has been smoothed by a primer 11. An electrically conductive polymer 12 is deposited thereon which, if necessary, is in turn provided with a primer 11. This is followed by the metalized layer 13 and, if desired for reasons of use, a protective layer 14. A primer 11 may also be required between the metalized layer 13 and the protective layer 14. A colored lacquer, not shown in FIG. 2a, may be applied to the protective layer for optical refinement. The position of the electrically conductive polymer 12 may be interchanged with the metalized layer 13. Each of the primers 11 used may function as a bonding agent. The tear strip 1 additionally contains an adhesive layer 15 for connecting it to the foil wrapper 2. If the tear strip 1 is pressed or sealed to the foil wrapper 1, there will be no need for the adhesive layer 15. Since the tear strip 1 is usually coiled on reels, it is useful to provide one of its sides with a release agent 9, in particular a silicon film. The release agent 9 of the tear strip 1 may also be a transfer ribbon 16 (FIG. 2c), with the transfer ribbon 16 being provided with alignment means 8, such as, for instance, perforations, magnetic tracks or optical markings for the precisely positioned application of the tear strip 1 on the foil wrapper 1.

### EXAMPLE 4

As a variant of Example 3, in the embodiment shown in FIG. 2a, the substrate 10 is coated on both surfaces with an electrically conductive polymer 12 being present on one surface and the metalized layer 13 on the other surface.

### EXAMPLE 5

A further variant is shown in FIG. 2c. Two partial strips 30, 31 which are manufactured independently of each other are joined together. The partial strips 30, 31 may, for instance, be glued, pressed or sealed together, and together they form the tear strip 1. Aside from other layers, one of the partial strips 30 consists of a substrate 10 and the electrically conductive polymer 12, and the other partial strip 31 essentially consists of a substrate 10 and the metalized layer 13. Depending upon future use and technological possibilities, the essential layers of the partial strips 30, 31 may be interchanged, and the partial strips 30, 31 may be joined at different positions.

### EXAMPLE 6

In a further embodiment of the tear strip 1 or the partial strips 30, 31 the electrically conductive polymer 12 is applied in a surface modulating manner. FIG. 3a schematically depicts the structure of a partial section of a tear strip 1. The differing application thicknesses and the changing surface resistence resulting therefrom result in a code. In this embodiment the modulated surfaces represent a specific code of the manufacturer (see FIG. 3a).

### EXAMPLE 7

This example describes a tear strip 1 or partial strips 30, 31 similar to the one described in connection with Example 6. The electrically conductive polymer 12 is applied sectionally. As shown in FIG. 3b, the sectional applications of polymer 12 result in sectionally changing surface resistances which, in turn, serve as codes which may represent such production data as channels, charges, places of destination, product classes or serial numbers.

### EXAMPLE 8

As a variant of Examples 6 and 7, a further embodiment of a tear strip or partial strips 30, 31 is proposed with reference to FIG. 3c. The electrically conductive polymer 12 is sectionally applied and every section of the sectional applications is applied in a surface modulating manner. A code is created as a result of the thus sectionally changing surface resistances. The code represent the manufacturer and the date of manufacture, and the surface-modulated sections create a code which represent a specific code of the manufacturer.

### EXAMPLE 9

In this Example one or more codes based on Examples 6, 7 and 8 are combined and realized in different surface directions. For instance, the electrically conductive polymer 12 is sectionally applied in a surface-modulating manner (see Example 8) and in another surface direction it is sectionally applied (see Example 7) so that different codes are created in the two directions.

### EXAMPLE 10

In a further embodiment of the tear strip 1 or partial tear strips 30, 31 a primer 11 is applied sectionally or surface-modulatingly or sectionally surface-modulatingly like the electrically conductive polymer in Examples 6 to 9. The resultant structure of the primer 11 application is transferred as a master pattern to the layer of the electrically conductive polymer 12 to be deposited and/or a metalized layer 13. Codes similar to those described in Examples 6 to 9 will result.

### EXAMPLE 11

FIG. 4a depicts the usual flow of goods or distribution channel for a tear strip 1. An automated manufacturer of security features manufactures the tear strip 1 and delivers it to a packer. There are many possibilities for product piracy and unauthorized manufacturers of obtaining this tear strip 1. Unfortunately, they are often incomprehensible for controlling persons. As shown in FIG. 4a the original tear strip 1 is diverted, for instance, during transport to the packer. FIG. 4b shows a separated flow of goods resulting from the tear strip 1 consisting of two or more components. Two manufacturers of thread components manufacture parts of a tear strip 1 and deliver them to a packer. Preferably, the partial strips 30, 31 are joined together at the packer's only a shown in FIG. 5, and each one separately or the combination of two joined ones represents codes. Advantageously, the partial strips 30, 31 or the combination of partial strips 30, 31 should be compatible with conventional systems. The thickness of the individual partial strips 30, 31 must be selected such that the total thickness of the tear strips 1 does not exceed the conventionally used thickness of 30-50 μm. The combination results in a significantly higher level of security in view of the fact that the two components reach the user by separate distribution paths. The two separately supplied components create a very high obstacle for forgers and criminals or unauthorized manufacturers and has been indicated in FIG. 4 b by broken arrows. As has been explained supra, each partial strip 30, 31 may by itself as well as in a combination of two partial strips 30, 31 represent a code. The combination of two partial strips 30, 31 results in an encoded tear strip 1. The manner in which the code is formed is shown in FIG. 6. Only the precise joining of the two partial strips 30, 31 will result in the desired code which represents the genuineness of the product. Different code versions can be obtained by selective joining of the two partial strips 30, 31. The individual encoding means may be of different, preferably electrical, magnetic, optical functionalities. Their number, arrangement, geometry and properties or a combination thereof results in codes which can be detected by a testing person. In the present embodiment the code of the partial strip 30 represents the place of manufacture and the code of the partial strip 31 represents manufacturing data 21.

### EXAMPLE 12

As a variation of Example 11, the codes in the individual partial strips 30, 31 are incomplete in this preferred embodiment and only in combination do they result in a decodable or detectable code. The individual partial strips 30, 31 may more particularly be provided with encoding means which may be affected physically, for instance, by an application of energy, in particular visible light, UV, IR, or heat radiation as well as by chemical effects. It is within the ambit of the invention to provide components of a reaction dye on the partial strips 30, 31 which will react when brought into contact with each other.

### EXAMPLE 13

By using the variants described in the examples a code is activated only by joining a tear strips 1 with a package. The result of combining the tears strip 1 with marking of the package, for instance, a positionally precise connection of the tear strip 1 with a foil wrapper 2, is a decodable or detectable code.

Aside from the described embodiments, the characteristics of the invention will be apparent as well from the claims and drawings, the characteristics by themselves or combined to sub-combinations representing advantageous, protectable embodiments for which protection is hereby claimed.

1. Security features, preferably tear strips or threads (1) for identification by the manufacturer or authorized control agents of the genuineness of products, consisting of substrates (10), integral or scattered metalized applications (13) of a defined surface resistance and electrically conductive polymers (12) of defined surface resistance, the difference between the surface resistances being greater than 100 kΩ/□ and the tear strips being connected to packages.

2. The security features of claim 1, characterized by the fact that the surface resistance of the integral or scattered metalized applications is greater than 200 kΩ/□.

3. The security features of claim 1, characterized by the fact that the surface resistance of electrically conductive polymers (12) is in the order of 15-100 kΩ/□.

4. The security features of claim 1 characterized by the fact that one or more substrates (10), electrically conductive polymers (12) and integral or scattered metalized applications (13) are arranged for selective interchangeability among each other.

5. The security features of claim 1, characterized by the fact that the tear strips (1) selectively contain protective layers (14), release agents (9) or adhesive layers (15) and that they are arranged interchangeably with each other.

6. The security features of claim 5, characterized by the fact that the release agent (9) preferably is a siliconized layer or a transfer ribbon (16) and is provided with alignment means (8), for instance perforations, magnetic tracks, optical markings or a combination thereof.

7. The security features of claim 1, characterized by the fact that the tear strips (1) contain primers (11), the primers (11) smoothing the substrates (10) and serving as bonding agents.

8. The security features of one or more of the preceding claims, characterized by the fact that electrically conductive polymers (12), integral or scattered metalized applications (13), substrates (10), protective layers (14) and primers (11) are selectively arranged as encoding means.

9. The security features of one or more of the preceding claims, characterized by the fact that the encoding means have electrical and/or optical and/or magnetic functionalities.

10. The security features of one or more of the preceding claims, characterized by the fact that the electrically conductive polymers (12) are applied sectionally or surface-modulatingly or sectionally surface-modulatingly.

11. The security features of one or more of the preceding claims, characterized by the fact that the surface resistance of the electrically conductive polymers (12) is a readable code which is detectable especially by capacitive coupling.

12. The security features of one or more of the preceding claims, characterized by the fact that the integral or scattered metalized applications (13) are applied sectionally or surface-modulatingly or sectionally surface-modulatingly.

13. The security features of one or more of the preceding claims, by the fact that the surface resistance of the integral or scattered metalized application (13) is a readable code which is detectable especially by capacitive coupling.

14. The security features of one or more of the preceding claims, characterized by the fact that the encoding means may be physically or chemically affected.

15. The security features of one or more of the preceding claims, characterized by the fact that the encoding means as security element in the tear strips (1) and/or in conjunction with the package react by an application of energy, especially visible light, UV, IR or heat radiation.

16. The security features of one or more of the preceding claims, characterized by the fact that the encoding means consists of components of a reaction dye and react only by contact of the components.

17. The security features of one or more of the preceding claims, characterized by the fact that the primers (11) are applied sectionally or in a surface modulating manner.

18. The security features of one or more of the preceding claims, characterized by the fact that the electrically conductive polymer (13) is a polyethylene dioxythiophene polystyrene sulfonate.

19. Security features, preferably tear strips or threads for the identification by the manufacturer or authorized control agent of the genuineness of products as described in claims 1 to 18, consisting of several partial strips (30, 31), each partial strip (30, 31) consisting of substrates (10), integral or scattered metalized applications (13) of a defined surface resistance or of electrically conductive polymers (12) of a defined resistance or of a combination thereof, the difference between the surface resistances being greater than 100 kΩ/□ and that the tear strips (1) made by joining partial strips (30, 31) are connected to packages.

20. The security features of claim 19, characterized by the fact that one or more substrate (10), electrically conductive polymers (12) integral or scattered metalized applications (13), protective layers (14) release agents (9), alignment means (8), primers (11) and adhesive layers (15) are arranged for selective interchangeability with each other and that they arranged in different numbers in the individual partial strips (30, 31).

21. The security features of claims 19 and 20, characterized by the fact that the layer structure of the partial strips (30, 31) is arranged such that they contain their own encoding means and that in their joined state the partial strips (30, 31) contain different compounded encoding means.

22. The security means of claims 19 to 21, characterized by the fact that encoding means, for instance the place of manufacture (20) or production data (21), are arranged by the number, arrangement and/or geometry of the substrates (10), electrically conductive polymers (12), integral or scattered metalized applications (13) and their precisely interfitting joining as tear strips (1).

23. The security features of one or more of claims 19 to 22, characterized by the fact that components of a reaction dye are contained in the partial strips (30, 31) and that the components only react to form an encoding means when brought into contact with each other.

24. The security features of one or more of the preceding claims 1 to 23, by the fact that the tears strips (1) and/or partial strips (30, 31) contain encoding means and that these are sectionally or surface-modulatingly or partially surface-modulatingly arranged in different surface directions.
